(19) United States
(12) Patent Application Publication
(10) Pub. No.: US 2025/0049265 A1
(43) Pub. Date: Feb. 13, 2025

(54) Single-use disposable footbath basin liner including a porous enclosure containing foot bath product

(71) Applicant: PURE VITAMIN SPA LLC, Houston, TX (US)

(72) Inventor: Hai Nguyen, Peoria, AZ (US)

(73) Assignee: PURE VITAMIN SPA LLC, Houston, TX (US)

(21) Appl. No.: 18/668,592

(22) Filed: May 20, 2024

Related U.S. Application Data
(60) Provisional application No. 63/467,774, filed on May 19, 2023.

(51) Int. Cl. A47K 3/00; A47K 3/022

(52) U.S. Cl. CPC A47K 3/001; A47K 3/022

(57) ABSTRACT

An improved single-use disposable footbath liner includes a porous packet for enclosing footbath products. The porous packet is attached at least indirectly to the inside surface of the single-use disposable footbath basin liner and is positioned so that the product contained therein is dissolved and released into the footbath when water is introduced into a footbath basin in which single-use disposable footbath basin liner has been installed.

### CROSS REFERENCES TO RELATED APPLICATIONS

This application claims the benefit of U.S. Provisional Patent Application 63/467,774 which was filed on 19 May 2023 and which is incorporated herein by reference in its entirety.

### FIELD

This invention relates to a pedicure footbath liner that includes a porous enclosure that contains at least one additive product for a footbath.

### BACKGROUND

Footbaths are used in combination with pedicure treatments to soften and sooth the foot and facilitate various pedicure procedures. In the course of a pedicure footbath, it is often the case that footbath products are added to the bath water in a footbath basin to accomplish various desired effects. In the past, pedicure technicians have measured the desired product from a container of product and added it to the footbath water. Recently, because of various health concerns, disposable liners have been introduced for lining the footbath basin for each customer use. It would be advantageous if various of the most common footbath additive products were packaged with such disposable liners.

### SUMMARY

The above-described need is addressed by footbath basin liner that includes a porous packet that is at least indirectly attached to a footbath basin liner such that the porous packet contains a footbath product or at least two footbath products that are able to dissolve into the water of a footbath.

### BRIEF DESCRIPTION OF THE DRAWINGS

FIG. 1 is a cross section side view of a footbath basin including a prior art single-use disposable footbath basin liner that is placed around and inside the footbath basin.

FIG. 2 is a cross section side view of a footbath basin including one embodiment of the present single-use disposable footbath basin liner that includes an attached porous packet that contains footbath product.

FIG. 3 is a cross section side view of a footbath basin including one embodiment of the present single-use disposable footbath basin liner that includes an attached porous packet that contains footbath product and also showing the presence of the feet of a pedicure recipient and water that has been poured into the lined pedicure footbath basin in order to provide a pedicure footbath.

FIG. 4 shows a cross section of a portion of the inside surface of one embodiment of a single-use disposable footbath basin liner that includes a porous packet that contains footbath product that is connected to the inside surface of the single-use disposable footbath basin liner

FIG. 5 shows a cross section of a portion of the inside surface of a second embodiment of a single-use disposable footbath basin liner that includes a porous packet that contains footbath product that is adhesively mounted to the inside surface of the single-use disposable footbath basin liner.

FIG. 6 shows a cross section of a portion of the inside surface of a third embodiment of a single-use disposable footbath basin liner that includes a porous blister that encloses footbath product, the porous blister being adhesively mounted around its peripheral edges to the inside surface of the single-use disposable footbath basin liner.

### DETAILED DESCRIPTION

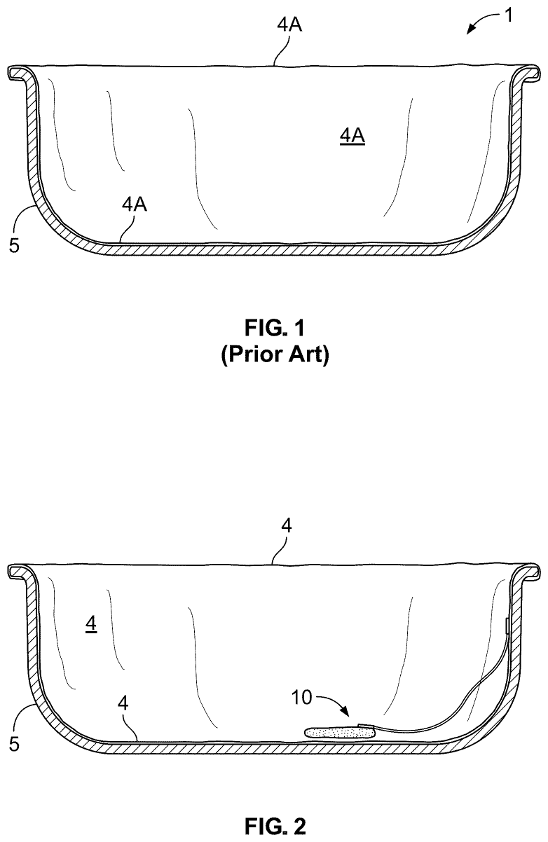

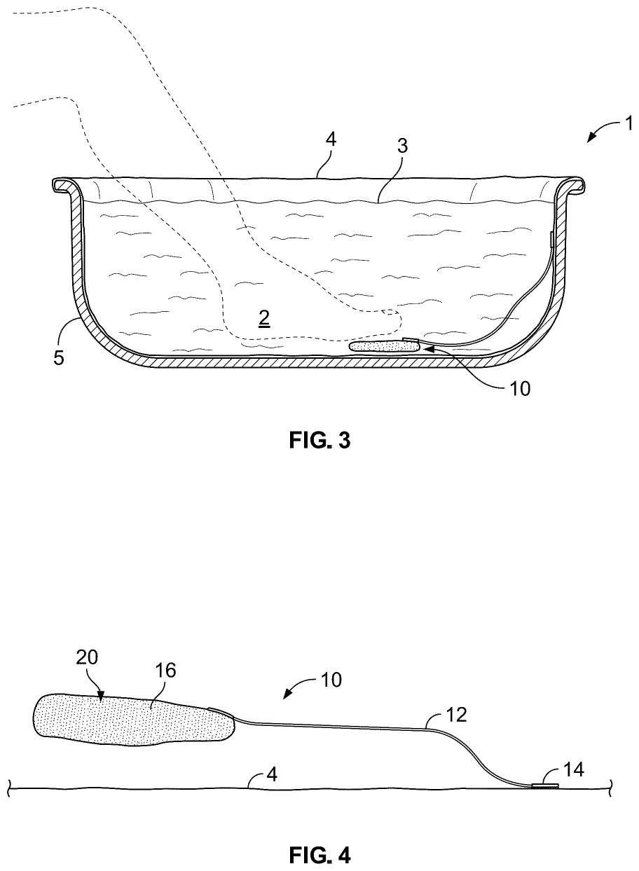

As can be seen in FIG. 3, a pedicure footbath arrangement 1 includes a single-use disposable footbath basin liner 4 which is installed into a pedicure footbath basin 5. An appropriate quantity of water 3 has been added to basin 5 and a pair of feet 2 of a pedicure recipient have also been submerged into water 3. Liner 4 has an inner surface and an opposite outer surface that lays against the inside surface of single-use disposable footbath basin liner 4. A porous packet assembly 10 is attached to the inner surface of single-use disposable footbath basin liner 4. FIG. 1 shows a basin 5 into which a prior art, unmodified single-use disposable basin liner 4P has been installed prior to the introduction of water into basin 5. FIG. 2 shows a basin 5 into which the present single-use disposable footbath basin liner 4 that includes an attached packet assembly 10 has been installed prior to the introduction of water into basin 5. Packet assembly 10 will be described in greater detail below.

As can be seen in greater detail in FIG. 4, a packet assembly 10 is attached to a portion of the inside surface of single-use disposable footbath basin liner 4. Packet assembly 10 includes a tab 14, an elongated attaching element 12 a porous packet 16 than encloses footbath product material 20. Tab 14 is preferably by a water proof adhesive to the inside surface of single-use disposable footbath basin liner 4. Elongated attaching element 12 may be a segment of string or a strip of plastic sheet material or any other suitable material. Single-use disposable footbath basin liner 4 may be of a type that is well known in the art and is typically fashioned from thin waterproof plastic sheet. By way of example, single-use disposable footbath basin liner 4 may similar to or comparable to footbath basin liners that are readily available and well known in the art. Elongated attaching element 12 is also attached to porous packet 16. However, elongated attaching element 12 may also be easily breakable so that packet 16 may be able to move freely in the footbath once the footbath has commenced.

Porous packet 16 is preferably fashioned from a porous mesh-like material that maintains its integrity when submerged in water. However, optionally, packet 16 may be fashioned from a water-soluble material so that its contents are able to be released into water 4 when water 4 is added to basin 5.

As noted above, porous packet 16 encloses and contains footbath product material 20. Footbath product material 20 (or footbath product material 120 or footbath product material 220 below) may contain any one of a number of pedicure products or even a combination of pedicure products. It is preferable that the pedicure product or products of footbath product material 20 be water soluble. In some embodiments a combination of a carbonate and an acid such as citric acid may be contained in packet 16 to provide effervescence. Granular bath salts and even product tablets may be enclosed by packet 16. By way of example, there are a number of products that may be contained in packet 16 (and other embodiments, namely, packet 116 and enclosure portion 216 described below) such as may include such ingredients selected from the following group: salt, fragrance, dye and soap powders. However, these ingredients as indicated here are not intended to encompass all of products or ingredients that may contained within packets 16, 116 or 216.

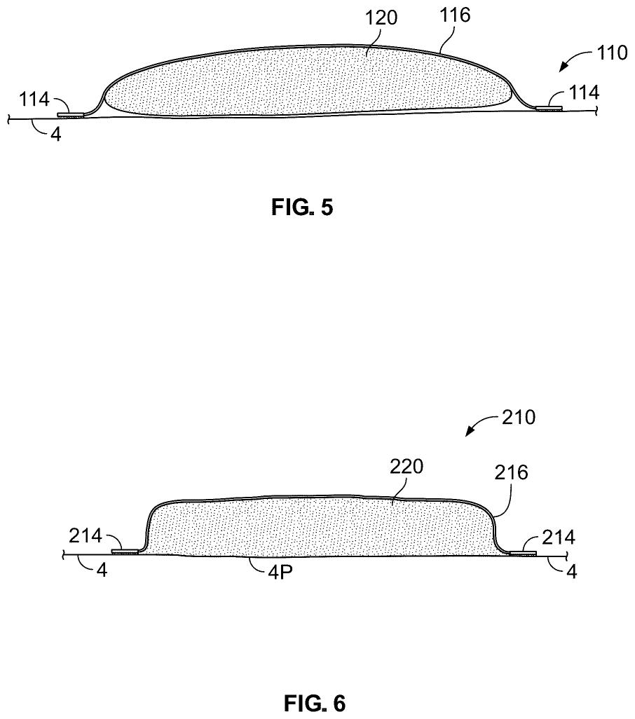

FIG. 5 shows a cross section view of a second embodiment packet assembly 110 which includes a second embodiment porous packet 116. Porous packet 116 also contains footbath product material 120. However, in this second embodiment, porous packet 116 is adhesively secured to the inside surface of single-use disposable footbath basin liner 4 around the periphery of packet 116 by an attachment lip 114. Attachment lip 114 may be adhesive in nature and it is preferable that the adhesive that secures attachment lip 114 to the inside surface of single-use disposable footbath basin liner 4 is not water soluble.

FIG. 6 shows a cross section view of a third embodiment packet assembly 210 which includes a third embodiment porous enclosure portion 216. Porous enclosure portion 216 is arranged so that it defines an offset porous wall that encloses footbath product material 220 within a volume that is bounded by porous enclosure portion 216 and a corresponding adjacent portion 4P of the inside surface of single-use disposable liner 4. In this third embodiment, porous enclosure portion 216 is adhesively secured to the inside surface of single-use disposable liner 4 around the periphery of enclosure portion 216 by an attachment lip 214.

As can be seen from the above detailed description, the improved single-use disposable pedicure footbath liner that includes an attached porous packet containing at least one footbath product provides a convenient and efficient arrangement for providing a pedicure footbath. At least two or possibly three steps are eliminated from the footbath process because when the liner is installed in the pedicure footbath basin the desired product for enhancing the footbath is also present without the need to execute any additional steps.

A method for using pedicure footbath liner which includes a porous footbath product packet is as follows: 1. Obtain a pedicure footbath basin. 2. Install a single-use disposable footbath basin liner in the footbath basin that has a porous footbath product packet attached to the inside surface of the single-use disposable footbath basin liner. 3. Introduce water into the pedicure footbath basin such that the water submerges the footbath product packet, while also either subsequently or previously or simultaneously introducing the feet of a pedicure recipient into the basin so as to be at least partially submerged in the water of the footbath in order to bath the feet of the pedicure recipient in a water solution that includes product from the porous footbath product packet as the product is released from the porous footbath product packet.

It is to be understood that while certain forms of this invention have been illustrated and described, it is not limited thereto, except in so far as such limitations are included in the following claims and allowable equivalents thereof.

Having thus described the invention, what is claimed as new and desired to be secured by Letters Patent is:

1. An improved single-use disposable footbath basin liner having an inside surface and an outside surface, comprising:
a porous packet that encloses at least one footbath product, the porous packet being attached at least indirectly to the inside surface of the single-use disposable footbath basin liner, the single-use disposable footbath basin liner being installed in a footbath basin such that the outside surface of the single-use disposable footbath basin liner is in contact with the inside surface of the footbath basin and inside surface of the single-use disposable footbath basin liner is facing away from the inside surface of the footbath basin, the porous packet also being positioned so that the at least one product contained within the porous packet is dissolved and released into water when water is introduced into the footbath basin.

2. The improved single-use disposable footbath basin liner of claim 1, wherein the porous packet is anchored by a chord to the inside surface of the footbath basin liner.

3. The improved single-use disposable footbath basin liner of claim 1, wherein the porous packet is adhesively fixed by at least a portion of its periphery to the inside surface of the footbath basin liner.

4. The improved single-use disposable footbath basin liner of claim 1, wherein the porous packet is defined by a portion of porous material that is adhesively fixed around its periphery to the inside surface of the footbath basin liner and at least one footbath product is contained between the porous material and the portion of the inside surface of the footbath liner that is adjacent to the porous material.
